(19) United States
(12) Patent Application Publication
(10) Pub. No.: US 2024/0309696 A1
(43) Pub. Date: Sep. 19, 2024

(54) DOUBLE HUNG WINDOW

(71) Applicant: Alchin Long Group IP Pty Limited, Wetherill Park (AU)

(72) Inventor: David WINSTON, Wetherill Park (AU)

(21) Appl. No.: 18/604,172

(22) Filed: Mar. 13, 2024

(30) Foreign Application Priority Data
Mar. 15, 2023 (AU) 2023900701

(51) Int. Cl. E06B 3/44

(52) U.S. Cl. CPC E06B 3/4415

(57) ABSTRACT

A double hung window (100) including:
a frame (110) including a sill (112), two upstanding jambs (114), and a head (116) to define an opening (118);
a first sash (120) mounted between the jambs (114), the first sash (120) being moveable relative to the jambs (114);
a second sash (130) mounted between the jambs (114), the second sash (130) being moveable relative to the jambs (114); and
a first linear actuator (170) mounted in one of the jambs (114) and configured to move the first sash (120) relative to the jambs.

### RELATED APPLICATIONS

The present application claims priority to Australian Provisional Patent Application No. 2023900701, filed Mar. 15, 2023, the contents of which are incorporated herein in their entirety by reference thereto.

### FIELD

The present invention relates to a double hung window.

### BACKGROUND

Double hung windows are a popular style of window due to their flexibility in opening up only an upper portion or a lower portion of the window opening, facilitating a selective exchange of cold or hot air. They are also popular because they have very little, if any, required swing out area making them flexible design choices.

However, the weight of sashes places a natural limit to the size of double hung windows, as their movement needs to be feasible using an average person's arm strength, and their position must be held by an appropriately sized friction mechanism. Large double hung windows are impractical due to their weight requiring substantial friction mechanisms and/or complex counter-weight and/or pulley mechanisms to allow the sash to be easily moved.

### SUMMARY

It is an object of the present invention to at least substantially address one or more of the above disadvantages, or at least provide a useful alternative to the above discussed double hung windows.

There is disclosed a double hung window including:
a frame including a sill, two upstanding jambs, and a head to define an opening;
a first sash mounted between the jambs, the first sash being moveable relative to the jambs;
a second sash mounted between the jambs, the second sash being moveable relative to the jambs; and
a first linear actuator mounted in one of the jambs and configured to move the first sash relative to the jambs.

Preferably, the window further includes a second linear actuator mounted in one of the jambs and configured to move the second sash relative to the jambs.

Preferably, each jamb includes an extrusion profile with a first longitudinally extending channel, the first sash being mounted to within the first channel such that the movement of the first sash relative to the jambs is defined by the first channel, and
wherein the first linear actuator is mounted within the first channel.

Preferably, the extrusion profile includes a second longitudinally extending channel, the second sash being mounted to within the second channel such that the movement of the second sash relative to the jambs is defined by the second channel, and
wherein the second linear actuator is mounted within the second channel.

Preferably, the first actuator is upwardly moveable from a retracted position to an extended position to move the first sash upwards.

Preferably, the second actuator is downwardly moveable from a retracted position to an extended position to move the first sash downwards.

Preferably, the window includes a sash connector and each sash is connected to the respective linear actuator using the sash connector.

Preferably, the sash connector is configured to be attachable to the respective linear actuator after the respective sash has been mounted between the jambs and the linear actuator has been installed.

Preferably, the sash connector is connected to the respective linear actuator in a first direction, and secured to the linear actuator using a fastener that is inserted from a second direction, wherein the first direction and the second direction are orthogonal.

Preferably, the sash connector includes a sash bracket that is received by a first slot in the linear actuator that is oriented in the first direction, and wherein the fastener is received by a second slot and is movable in the second slot in the second direction.

Preferably, the sash bracket is moveable from a retracted position, in which the sash is moveable past the linear actuator, and an extended position, in which the sash bracket is able to abut the linear actuator for connection thereto.

Preferably, the sash connector includes a displacement mechanism that is actuable from a jamb side of the sash connector to move the sash bracket between the retracted and extended positions.

Preferably, the displacement mechanism includes:
a lead screw having a slot,
a pin connecting the sash bracket to the slot, the pin being driven by the lead screw.

Preferably, movement of the pin is limited by a cavity in which the pin moves between positions corresponding to the retracted and extended positions of the sash bracket.

Preferably, the fastener includes a body having a pin extending from the body to engage the linear actuator, and wherein the fastener is moveable in the second direction between a first position, wherein the pin does not engage the sash bracket, and a second position, wherein the pin engages the sash bracket.

Preferably, the fastener further includes a fixation screw and the linear actuator includes a fixation recess oriented parallel to the first direction, and
wherein, when the fastener is in the second position, the fixation screw is connectable to the fixation recess.

Preferably, the fastener further includes a sprung pin located in a pin cavity of the fastener, the pin cavity being oriented perpendicular to the second direction, and
wherein, when the fastener is moved from the first position to the second position, the sprung pin is biased to engage a locating recess formed in the sash connector to removably connect the fastener to the sash connector.

Preferably, the locating recess is located such that, when the sprung pin engages the locating recess, the fixation screw is aligned with the fixation recess.

Preferably, the pin cavity is oriented parallel to the first direction.

Preferably, the first sash and the second sash are independently movable.

Preferably, the first linear actuator includes a linear actuator for each jamb, and
wherein the second linear actuator includes a linear actuator for each jamb.

### BRIEF DESCRIPTION OF THE DRAWING

Preferred embodiments of the present invention will now be described by way of example, with reference to the accompanying drawings, wherein:

FIG. 1 is a front view of a double hung window according to a preferred embodiment of the invention.

FIG. 2 is a section view along the line D-D of FIG. 1.

FIG. 3 is a section view along the line E-E of FIG. 1.

FIG. 4 is an exploded perspective view of the double hung window of FIG. 1.

FIG. 5 is an exploded front view of the double hung window of FIG. 1.

FIG. 5A is a perspective view of the double hung window of FIG. 1 in an open position.

FIG. 5B is a cut-away perspective view of the double hung window of FIG. 5A.

FIG. 6 is an exploded perspective view of a linear actuator of the double hung window of FIG. 1.

FIG. 7 is a detail of FIG. 6.

FIG. 8 is a detailed section view of the double hung window of FIG. 1 prior to connection of the sash with the linear actuator.

FIG. 9 is a detailed section view of the double hung window of FIG. 1 after to connection of the sash with the linear actuator.

FIG. 10 is a detailed section view of the double hung window of FIG. 1 prior to connection of the sash with the linear actuator, according to a second embodiment.

FIG. 11 is a detailed section view of the double hung window of FIG. 1 after to connection of the sash with the linear actuator, according to the embodiment of FIG. 10.

FIG. 12 is a detail of an exploded perspective view of a linear actuator of the double hung window according to another embodiment.

### DETAILED DESCRIPTION

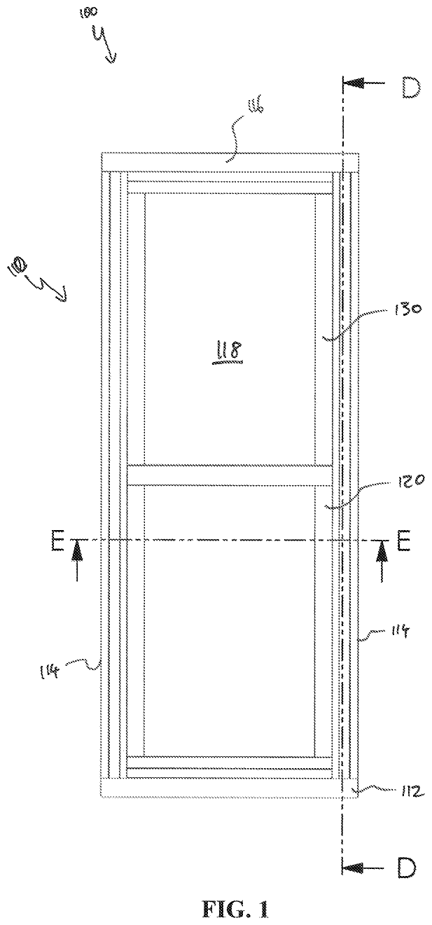

FIG. 1 shows a double hung window 100 according to a preferred embodiment of the invention. The window 100 includes a frame 110 having a horizontal sill 112, two jambs 114 upstanding from the sill 112, and a head 116 connecting the jambs 114 to define an opening 118. The window 100 further includes a first sash 120 mounted between the jambs 114 such that the first sash 120 is movable relative to the jambs 114, and a second sash 130 mounted between the jambs 114 such that the second sash 130 is movable relative to the jambs 114. Together, the first sash 120 and the second sash 130 are adapted to cover the opening 118 when desired, and to selectively uncover the opening 118 by moving relative to the jambs 114 when desired.

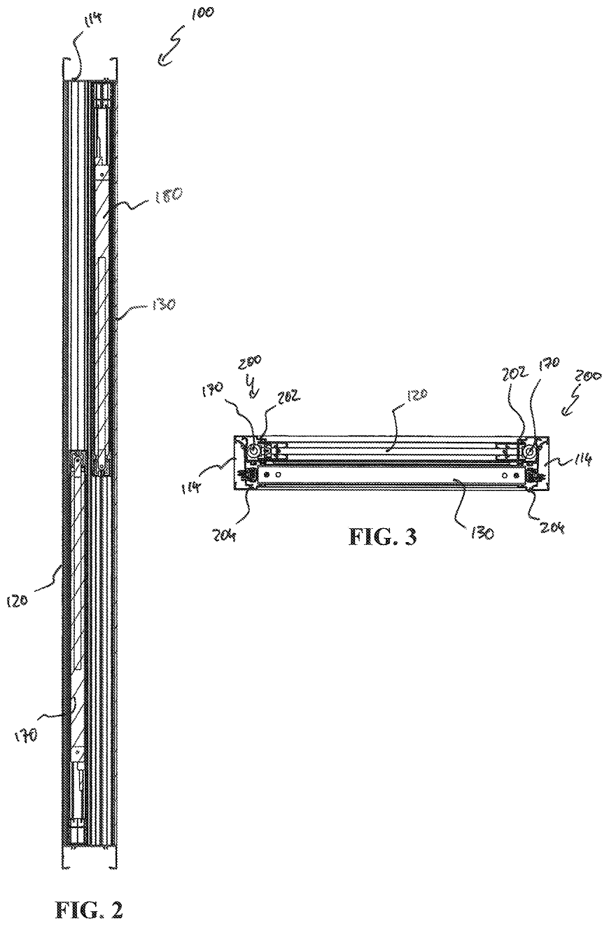

Moving to FIG. 2, the window 100 further includes a first linear actuator 170 mounted in one of the jambs 114 and configured to move the first sash 120 relative to the jambs 114. The window 100 also includes a second linear actuator 180 mounted in one of the jambs 114 and configured to move the second sash 130 relative to the jambs 114.

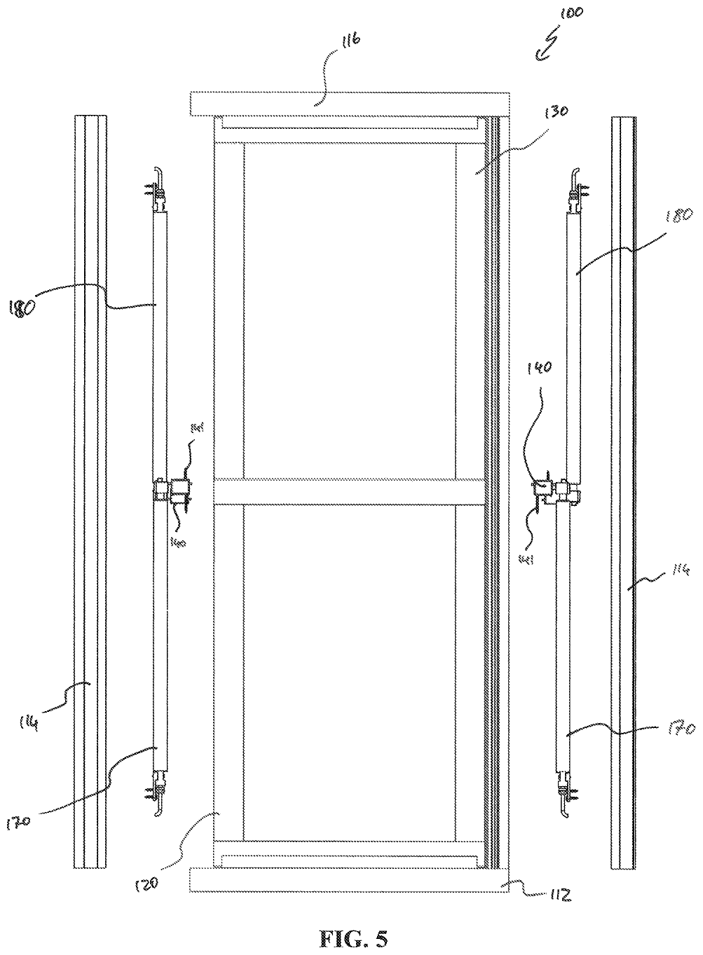

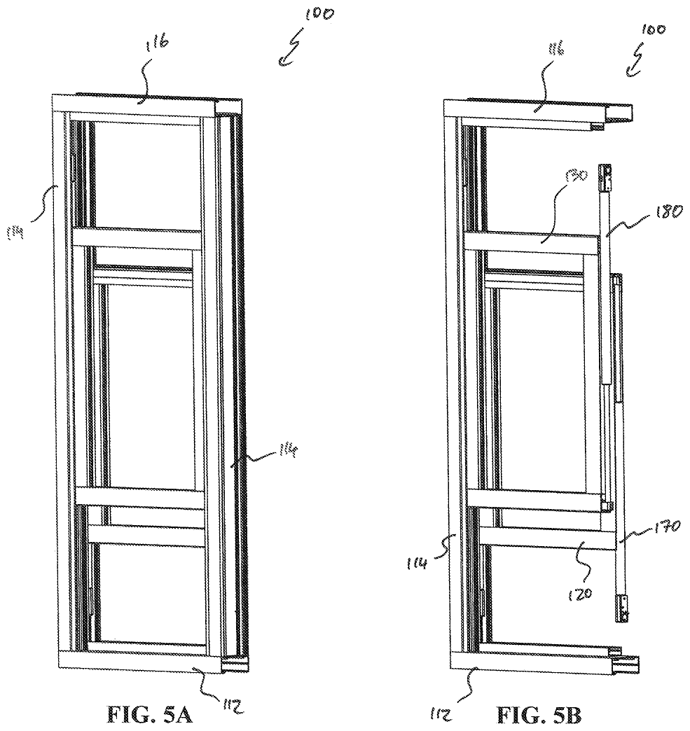

As seen in FIG. 3, each jamb 114 includes an extrusion profile 200, with a first channel 202 and a second channel 204. The first sash 120 is mounted in the first channel 202 such that movement of the first sash 120 relative to the jambs 114 is defined by the first channel 202. Similarly, the second sash 130 is mounted in the second channel 204 such that movement of the second sash 130 relative to the jambs 114 is defined by the second channel 204. In this way, the first sash 120 and second sash 130 can move past each other. The first linear actuator 170 is mounted in the first channel 202, and the second linear actuator 180 is mounted in the second channel 204. The first linear actuator 170 is upwardly moveable from a retracted position, shown in FIG. 2, to an extended position, shown in FIG. 5B to move the first sash 120 upwards. The second linear actuator 180 is downwardly moveable from a retracted position, shown in FIG. 2, to an extended position, shown in FIG. 5B, to move the second sash 130 downward.

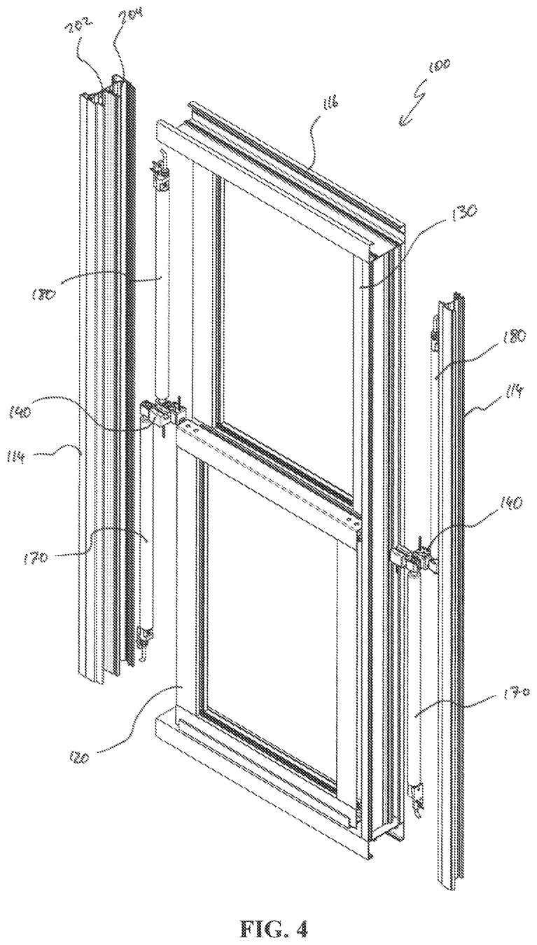

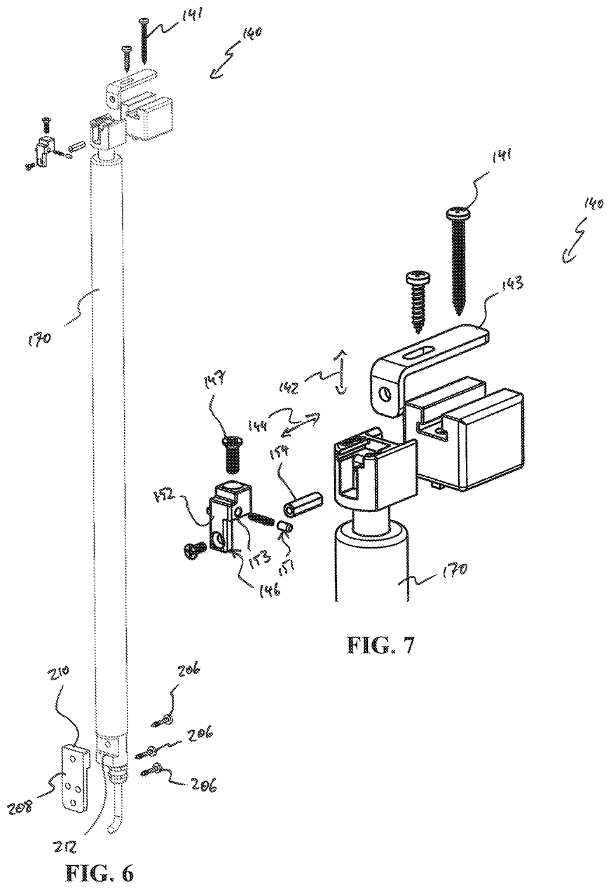

Moving now to FIGS. 4 and 5, the window 100 further includes a sash connector 140 to connect each sash 120, 130 to the respective linear actuator 170, 180. Shown in more detail in FIGS. 6 and 7, the sash connector 140 is adapted to be mounted to the respective sash 120, 130 using sash fastener 141. The sash connector 140 is thus configured to be attachable to the respective sash 120, 130, after the sash 120, 130 has been mounted between the jambs 114, and after the linear actuator 170, 180 has been installed. The sash connector 140 further includes a sash bracket 143 that connects the sash connector 140 to the linear actuator 170, 180. The connection using the sash bracket 143 occurs in a first direction 142, and is secured to the linear actuator 170, 180 using a fastener 146 that is inserted from a second direction 144. Preferably, the first direction 142 and the second direction 144 are orthogonal.

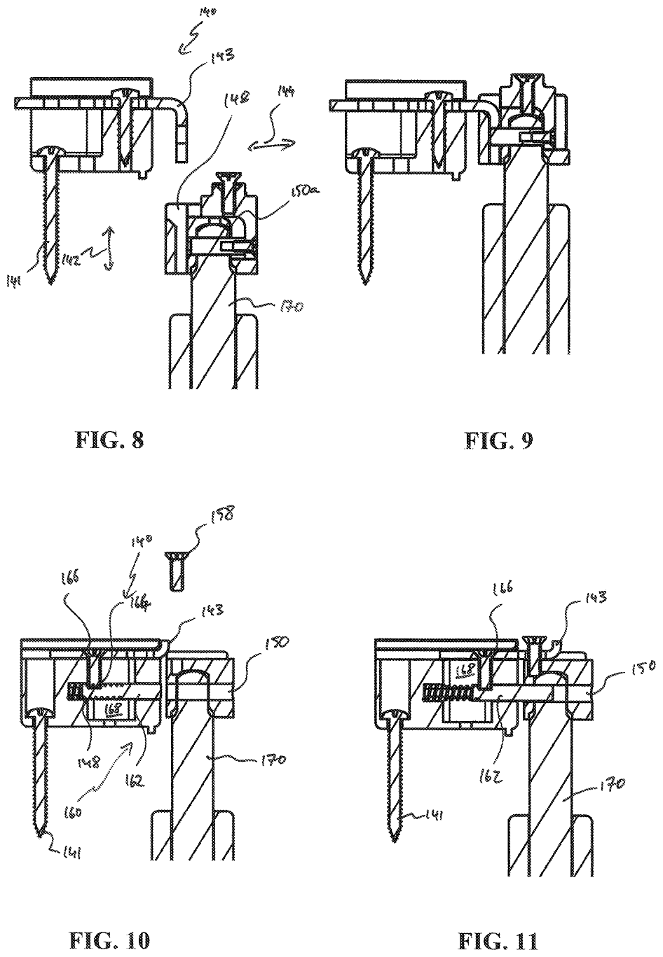

As shown in FIGS. 8 and 9, the sash bracket 143 is preferably received by a first slot 148 in the linear actuator 170, 180 that is oriented in the first direction 142, and the fastener 146 is received by a second slot 150 oriented in the second direction 144. The fastener 146 preferably includes a body 152 with a pin 154 extending from the body 146 to engage the linear actuator 170, 180. The pin 154 may be comprised of a tapped cylinder and a fastener to attach the tapped cylinder to the body 152. The fastener 146 is moveable in the second direction 144 between a first position, wherein the pin 154 does not engage the sash bracket 143, and a second position, wherein the pin 154 engages the sash bracket 143. Preferably, the second slot 150 includes a thruhole 150a that pin 154 uses to traverse the linear actuator 170, 180 through before engaging the sash bracket 143, so that on engagement, the pin 154 connects the sash bracket 143 to the linear actuator 170, 180.

As also seen in FIGS. 8 and 9, the fastener 146 further includes a fixation screw 147. The linear actuator 170, 180 includes a fixation recess 149 oriented parallel to the first direction 142, such that, when the fastener 146 is in the second position, the fixation screw 147 is connectable to the fixation recess 149 to fix the fastener 146 relative to the linear actuator 170, 180.

Moving briefly back to FIG. 7, the fastener 146 may further include a sprung pin 151 located in a pin cavity 153 of the fastener 146. The pin cavity 153 is preferably oriented perpendicularly to the second direction 144 in which the fastener 146 moves between the first position and the second position. When the fastener 146 is moved from the first position to the second position, the sprung pin 151 is biased to engage a locating recess 155 formed in the sash connector 140 to removably connect the fastener 146 to the sash connector 140. The location of the locating recess 155 is preferably selected such that, when the sprung pin 151 engages the locating recess 155, the fixation screw 147 is aligned with the fixation recess 149.

In another embodiment shown in FIGS. 10 and 11, the sash bracket 143 is moveable between a retracted position, shown in FIG. 10, and an extended position, shown in FIG. 11. When the sash bracket 143 is in the retracted position, the sash 120, 130 can move past the linear actuator, such that the sash 120, 130 and the linear actuator 170, 180 can be installed without interfering with each other, In the extended position, the sash bracket 143 protrudes further into the extrusion profile 200 to abut the linear actuator 170, 180 for connection thereto. The connection is completed by a bracket fastener 158. Preferably, as shown in FIGS. 10 and 11, the sash connector 140 includes a displacement mechanism 160 that is actuable from a jamb 114 side of the sash connector 140 to move the sash bracket 143 between the retracted and extended positions. The displacement mechanism 160 may, for example, be embodied including a lead screw 162 received by a tapped first slot 148 in the sash connector 140. The lead screw 162 has a slot 164 within which a pin 166 is located that connects to the sash bracket 143. The pin 166 is driven by the lead screw 162 as it is constrained in the slot 164, and thus moves the sash bracket 143 as the lead screw 162 is driven. Movement of the pin 166 is preferably limited by a cavity 168 in which the pin 166 moves between positions corresponding to the retracted and extended positions of the sash bracket 143. The linear actuator 170, 180 preferably includes a second slot 150 that receives the lead screw 162 as it is actuated in the tapped first slot 148, such that a connection is made between the lead screw 162, the linear actuator 170, 180 and the sash connector 140.

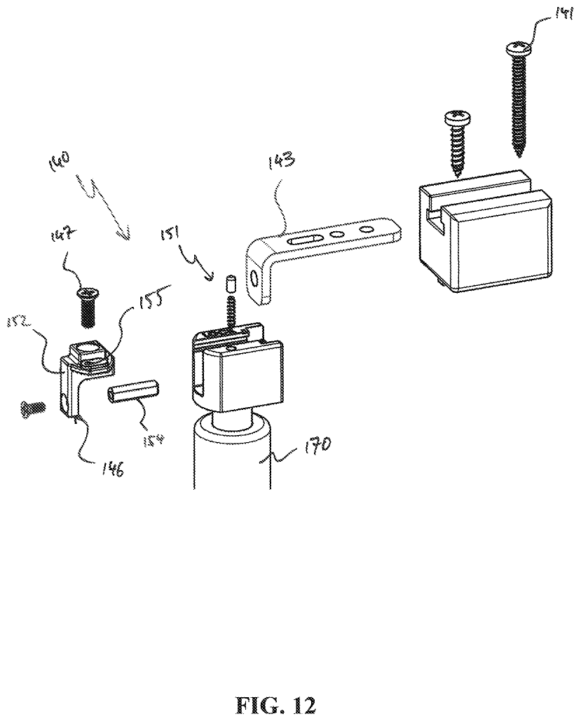

In another embodiment shown in FIG. 12, the sprung pin 151 is oriented parallel to the first direction 142, as is the locating recess 155 that receives the sprung pin 151 when the fastener 146 is in the second position.

As a result of being connected to the linear actuators 170, 180, the sashes 120, 130 are independently movable, and may be moved by remote actuation of the linear actuators 170, 180. Preferably, the linear actuators 170, 180 include an electric linear motor. In another embodiment, the linear actuators 170, 180 include a pneumatic or hydraulic actuator. Preferably, as shown in FIGS. 4 and 5, the first linear actuator 170 includes a linear actuator for each jamb 114, and the second linear actuator 180 includes a linear actuator for each jamb 114.

Use of the window 100 will now be discussed.

Following installation of the frame 110, the linear actuators 170, 180 are installed into the jambs 114, by attaching the linear actuator 170, 180 into the respective channel 202, 204 using actuator fasteners 206 as shown in FIG. 6. In one embodiment, the actuator fasteners 206 fasten an actuator plate 208 having a hook 210 that is engaged by a corresponding hook 212 of the linear actuator 170, 180 to install the linear actuator 170, 180. The sashes 120, 130 are then mounted into the extrusion profile 200. The sashes 120, 130 are freely moveable relative to the linear actuators 170, 180.

The sash connectors 140 are now attached to the sash 120, 130 at respective locations adapted for connection to the linear actuator 170, 180, using the sash fastener 141. If using the embodiment of FIGS. 8 and 9, the sash bracket 143 is then inserted into the first slot 148, and the fastener 146 is actuated to drive the cylinder 152 into the recess 156. The linear actuator 170, 180 is now connected to the sash 120, 130. If using the embodiment of FIGS. 10 and 11, the lead screw 162 is actuated to drive the sash bracket 143 to the extended position. The lead screw 162, as it is driven, extends from the first slot 148 and is received in the second slot 150 of the linear actuator 170, 180 to secure the sash 120, 130 to the linear actuator 170, 180 in a vertical direction. The sash bracket 143 further receives the bracket fastener 158 to secure the sash 120, 130 to the linear actuator 170, 180 in a horizontal direction.

The sash 120, 130 is now connected to the linear actuator 170, 180 and may be drive thereby relative to the jambs 114.

Advantages of the window 100 will now be discussed.

Because the first and second linear actuators 170, 180 are mounted in the jambs 114, the sash 120, 130 may be actuated while reducing the pinch risk of the actuators 170, 180. Further, less dirt and grime is likely to accumulate in the channels 202, 204 of the extrusion profile 200, decreasing the maintenance requirement of the window 100. The location of the linear actuators 170, 180 to move the sashes 120, 130 upwardly and downwardly, respectively, decreases the length requirement of the linear actuators 170, 180.

The use of the sash connector 140 allows the sashes 120, 130 and the linear actuators 170, 180 to be installed, and then connected, reducing the complexity of the system where movement space in the extrusion profile 200 is necessarily limited. The separation of the connections between the sash connector 140 and the linear actuator 170, 180 allows the connection bearing vertical forces to be appropriately sized, as this is the primary forces to be resisted, and the components securing the horizontal connection to be appropriately smaller sized, to reduce cost and space requirements. The use of the displacement mechanism 160 allows the movement of the sash bracket 143 to also form the vertical force connection between the sash connector 140 and the linear actuator 170, 180.

### INTEGERS

100 double hung window
110 frame
112 sill
114 jamb
116 head
120 opening
130 first sash
130 second sash
140 sash connector
141 sash fastener
142 first direction
143 sash bracket
144 second direction
146 fastener
147 fixation screw
148 first slot
149 fixation recess
150 second slot
151 sprung pin
152 body
153 pin cavity
154 pin
155 locating recess
156 recess
158 bracket fastener
160 displacement mechanism
162 lead screw
164 slot
166 pin
168 cavity
170 first linear actuator
180 second linear actuator
200 extrusion profile
202 first channel
204 second channel
206 actuator fasteners
208 actuator plate

1. A double hung window including:
a frame including a sill, two upstanding jambs, and a head to define an opening;
a first sash mounted between the jambs, the first sash being moveable relative to the jambs;
a second sash mounted between the jambs, the second sash being moveable relative to the jambs; and
a first linear actuator mounted in one of the jambs and configured to move the first sash relative to the jambs.

2. The double hung window of claim 1, wherein the window further includes a second linear actuator mounted in one of the jambs and configured to move the second sash relative to the jambs.

3. The double hung window of claim 1, wherein each jamb includes an extrusion profile with a first longitudinally extending channel, the first sash being mounted to within the first channel such that the movement of the first sash relative to the jambs is defined by the first channel, and
wherein the first linear actuator is mounted within the first channel.

4. The double hung window of claim 3, wherein the extrusion profile includes a second longitudinally extending channel, the second sash being mounted to within the second channel such that the movement of the second sash relative to the jambs is defined by the second channel, and
wherein the second linear actuator is mounted within the second channel.

5. The double hung window of claim 1, wherein the first actuator is upwardly moveable from a retracted position to an extended position to move the first sash upwards.

6. The double hung window of claim 1, wherein the second actuator is downwardly moveable from a retracted position to an extended position to move the first sash downwards.

7. The double hung window of claim 1, wherein the window includes a sash connector and each sash is connected to the respective linear actuator using the sash connector.

8. The double hung window of claim 7, wherein the sash connector is configured to be attachable to the respective linear actuator after the respective sash has been mounted between the jambs and the linear actuator has been installed.

9. The double hung window of claim 7, wherein the sash connector is connected to the respective linear actuator in a first direction, and secured to the linear actuator using a fastener that is inserted from a second direction, wherein the first direction and the second direction are orthogonal.

10. The double hung window of claim 9, wherein the sash connector includes a sash bracket that is received by a first slot in the linear actuator that is oriented in the first direction, and wherein the fastener is received by a second slot and is movable in the second slot in the second direction.

11. The double hung window of claim 10, wherein the sash bracket is moveable from a retracted position, in which the sash is moveable past the linear actuator, and an extended position, in which the sash bracket is able to abut the linear actuator for connection thereto.

12. The double hung window of claim 11, wherein the sash connector includes a displacement mechanism that is actuable from a jamb side of the sash connector to move the sash bracket between the retracted and extended positions.

13. The double hung window of claim 12, wherein the displacement mechanism includes:
a lead screw having a slot,
a pin connecting the sash bracket to the slot, the pin being driven by the lead screw.

14. The double hung window of claim 13, wherein movement of the pin is limited by a cavity in which the pin moves between positions corresponding to the retracted and extended positions of the sash bracket.

15. The double hung window of claim 10, wherein the fastener includes a body having a pin extending from the body to engage the linear actuator, and wherein the fastener is moveable in the second direction between a first position, wherein the pin does not engage the sash bracket, and a second position, wherein the pin engages the sash bracket.

16. The double hung window of claim 15, wherein the fastener further includes a fixation screw and the linear actuator includes a fixation recess oriented parallel to the first direction, and
wherein, when the fastener is in the second position, the fixation screw is connectable to the fixation recess.

17. The double hung window of claim 15, wherein the fastener further includes a sprung pin located in a pin cavity of the fastener, the pin cavity being oriented perpendicular to the second direction, and
wherein, when the fastener is moved from the first position to the second position, the sprung pin is biased to engage a locating recess formed in the sash connector to removably connect the fastener to the sash connector.

18. The double hung window of claim 17, wherein the fastener further includes a fixation screw and the linear actuator includes a fixation recess oriented parallel to the first direction, and
wherein, when the fastener is in the second position, the fixation screw is connectable to the fixation recess, and
wherein the locating recess is located such that, when the sprung pin engages the locating recess, the fixation screw is aligned with the fixation recess.

19. The double hung window of claim 17, wherein the pin cavity is oriented parallel to the first direction.

20. The double hung window of claim 1, wherein the first sash and the second sash are independently movable.

21. The double hung window of claim 1, wherein the first linear actuator includes a linear actuator for each jamb, and
wherein the second linear actuator includes a linear actuator for each jamb.
